(19) United States
(12) Patent Application Publication
(10) Pub. No.: US 2026/0364876 A1
(43) Pub. Date: Nov. 19, 2026

(54) PRINTHEAD FOR A 3D PRINTER

(71) Applicant: Robert Bosch GmbH, Stuttgart (DE)

(72) Inventors: Chris Nickels, Burgstetten-Erbstetten (DE); Hendrik Jahnle, Leutenbach (DE)

(21) Appl. No.: 19/136,964

(22) PCT Filed: Nov. 24, 2023
(86) PCT No.: PCT/EP2023/082937

§ 371 Date: Jun. 9, 2025

(30) Foreign Application Priority Data
Dec. 19, 2022 (DE) 10 2022 213 851.1

(51) Int. Cl. B29C 64/209; B29C 64/118; B33Y 30/00

(52) U.S. Cl. CPC B29C 64/209; B29C 64/118; B33Y 30/00

(57) ABSTRACT

The invention relates to a printhead (10) for a 3D printer (1), comprising a feed section (11) with an inlet (12) for feedstock (21) having a variable viscosity, a plasticizing section (14) with a heater (15) and an outlet port (16) for the liquid phase (22) of the feedstock (21), and a delivery device (30) for delivering the feedstock (21) from the feed section (11) to the plasticizing section (14), wherein the delivery device (30) comprises a piston (31) that can be introduced into the feed section (11), and the piston (31) has a first piston portion (5) facing the plasticizing section (14) and includes a guide surface (9), by means of which the piston (31) is guided in a cavity (7) in the printhead (10).

It is characterized in that the piston (31) is prevented from radial twisting within the cavity (7) in the printhead (10).

### BACKGROUND

The present invention relates to a printhead for a 3D printer.

A 3D printer for a material that varies in viscosity receives a solid phase of said material as the feedstock, generates a liquid phase therefrom, and selectively brings this liquid phase to the points associated with the object to be produced. Such a 3D printer comprises a printhead, in which the feedstock is made ready for printing. Furthermore, means are provided for generating a relative movement between the printhead and the work surface on which the object is to be created. Either only the printhead, only the work surface or both the printhead and the work surface can be moved.

The printhead has a first operating state in which liquid material exits from it and a second operating state in which no liquid material exits from it. For example, the second operating state is assumed when another position on the work surface is approached and no material is to be deposited on the way. For example, switching can be done between the two operating states of the printhead, in that the forward drive of the solid feedstock can be switched on or off.

It is known from DE 10 2016 222 306 A1 to plasticize a granulate via a piston and a heated section. When the piston presses on the granulate, it is compacted and delivered to a plasticizing section.

### SUMMARY

The underlying objective of the invention is to provide a printhead that can withstand the forces that occur and enables a stable printing process.

In the context of the invention, a printhead for a 3D printer was developed. This printhead comprises a feed section with an inlet for a feedstock that can vary in viscosity, a plasticizing section with a heater and an outlet port for the liquid phase of the feedstock, and a delivery device for delivering the granulate from the feed section into the plasticizing section, the delivery device comprising a piston that can be introduced into the feed section. Furthermore, the piston has a first piston section facing the plasticizing section, with a guide surface through which the piston is guided in a cavity of the printhead. In particular, the inlet can be designed for a feedstock in the form of granulate. The feedstock can in particular be a thermoplastic material.

According to the invention, the piston is prevented from radial twisting within the cavity of the printhead.

In a preferred further development, the piston is prevented from radial twisting by a form-fitting connection of the first piston section with the cavity of the printhead.

This arrangement of the piston in the cavity of the printhead effectively prevents the piston from jamming or becoming stuck in the cavity of the printhead, thus enabling virtually wear-free operation of the printhead. The invention ensures that the piston is always optimally guided in the cavity of the printhead and that it does not deviate, tilt or twist when it comes into contact with the granulate. This enables continuous and long-lasting operation of the printhead.

The form-fitting connection of the first piston section with the cavity of the printhead ensures that no rotation is transferred to the first piston section in the case of electrically driven actuators, in particular electric motors that generate a linear movement of the piston through a rotational movement. This is an advantageous way of preventing the piston, or the first piston section, from twisting in the cavity of the printhead.

The form-fitting connection can be achieved by symmetrical or asymmetrical shapes of the cross-sectional surface of the first piston section.

In a first exemplary embodiment, the first piston section and the cavity of the printhead have a polygonal, in particular hexagonal, cross-sectional surface.

The polygonal, in particular hexagonal cross-sectional surface forms an effective constructive measure against jamming of the first piston section in the cavity, since in an advantageous way a safe guidance of the piston is achieved by several guiding planes. This can be advantageous in minimizing wear and tear and extending the printhead's lifespan.

In a further exemplary embodiment, the first piston section and the cavity of the printhead have a part-circular, in particular semi-circular cross-sectional surface.

In a further exemplary embodiment, the first piston section and the cavity of the printhead have a cross-sectional surface in the shape of a segment of a circle.

The cross-sectional surface, which is part-circular, in particular semi-circular, or the cross-sectional surface, which is in the form of a segment of a circle, in each case forms an effective design measure against the first piston section jamming in the cavity, since, advantageously, the piston is guided securely along at least one guide plane. This can be advantageous in minimizing wear and tear and extending the printhead's lifespan.

In an extension, the axial extension of the guide surface of the piston is between 1.5 and 1.7 times the maximum axial extension of a port surface of the inlet to the cavity.

The size of the port surface of the inlet to the cavity is relevant for the amount of granulate fed from the inlet into the cavity of the printhead or into the feed section of the printhead.

The protrusion of the guide surface of the piston to the port surface of the inlet advantageously ensures stable guidance of the piston in the cavity.

Surprisingly, it has been found that with a piston that is prevented from radial twisting within the cavity of the printhead, a longer guide surface can be selected, thereby optimizing the piston guide and increasing the service life of the piston.

An axial extension of the piston's guide surface of 1.6 times the maximum axial extension of the inlet's port surface to the cavity has proven to be particularly favorable.

In a further training course, the first piston section has a cutting edge for shearing the feedstock at the port surface of the inlet.

The cutting edge cuts through the granulate, especially large granulate, that is within the port surface of the inlet. This is an effective way of ensuring that the first piston section does not get blocked by the granulate, but cuts through it. This avoids any possible underestimation of the first piston section. The cutting edge may be formed of hardened material or a separate cutting edge, in particular hard metal cutting.

### BRIEF DESCRIPTION OF THE DRAWINGS

Further measures for improving the invention are described in greater detail hereinafter, together with the description of the preferred exemplary embodiments of the invention, with reference to the figures.

Shown are:

FIG. 1 a printhead according to the invention;

FIG. 2 a sectional view of the printhead;

FIG. 3 a first exemplary embodiment of the printhead in a sectional view;

FIG. 4 a second exemplary embodiment of the printhead in a sectional view and

FIG. 5 another exemplary embodiment of the printhead in a sectional view.

### DETAILED DESCRIPTION

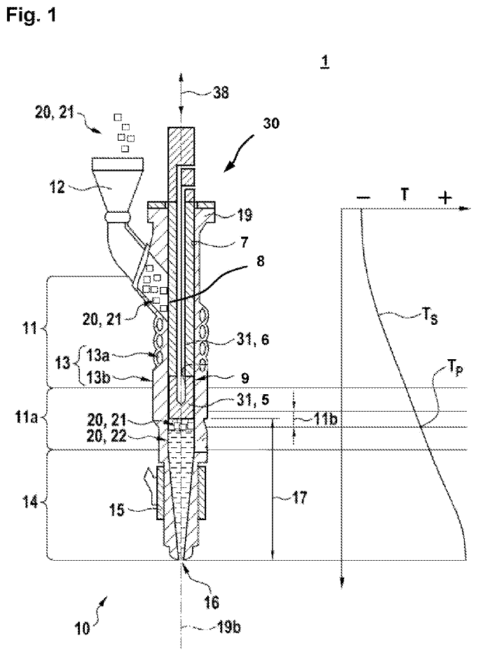

FIG. 1 shows a printhead 10 according to the invention. The printhead 10 for a 3D printer 1 comprises a feed section 11 with an inlet 12 for a feedstock 20, 21 whose viscosity can be varied, a plasticizing section 14 with a heater 15 and an outlet port 16 for the liquid phase 22 of the feedstock 21, and a delivery device 30 for delivering the feedstock 21 from the feed section 11 into the plasticizing section 14, the delivery device 30 comprising a piston 31 that can be introduced into the feed section 11. Piston 31 has a first piston section 5 facing plasticizing section 14, with a guide surface 9 through which piston 31 is guided in a cavity 7 of printhead 10. According to the invention, the piston 31 is prevented from radial twisting within the cavity 7 of the printhead 10, in particular by a form-fitting connection of the first piston section 5 with the cavity 7 of the printhead 10.

Furthermore, the printhead 10 comprises a housing 19 with a piston 31 guided therein. Piston 31 consists of the first piston section 5 and a second piston section 6. The first piston section 5 is guided in a sealing manner in the central cavity 7 of the housing 19 with respect to the feedstock 20, 21. It prevents the solid phase 21 of the feedstock 20 from escaping and pushes this solid phase 21 out of the feed section 11 into the compression section 11a, where a boundary layer 11b to the liquid phase 22 of the feedstock 20 is formed. The second piston section 6 is located above the first piston section 5 and is moved in a vertical direction 38, for example, by a spindle of a motor not shown. Electric motors are used preferentially. When the piston 31 moves in the direction of the outlet port 16 of the printhead 10, the liquid phase 22 of the feedstock 20 is expelled from the outlet port 16. FIG. 1 is a snapshot of the state in which exactly this is possible, i.e. the printhead 10 is ready to print. In this state, the working volume 17 inside the central cavity 7 in the housing 19 of the printhead 10 is comparatively small.

In the exemplary embodiment shown in FIG. 1, the solid phase 21 of the feedstock 20 is supplied via a funnel 12 and trickles into the feed section 11 in the printhead 10 as soon as the piston 31 is retracted behind this feed section 11. The feedstock 20 is preferably a granulate. To make this trickle possible, only the solid phase 21 of the feedstock may be present in the feed section 11. In particular, this solid phase 21 must not melt and stick. The feed section 11 is therefore cooled from the outside by coolant 13. The coolants 13 comprise an active cooling device 13a with a cooling medium and a passive cooling device 13b with cooling fins. This helps to ensure that the temperature TS in the feed section remains below the temperature TP at which the solid phase 21 of the feedstock 20 begins to plasticize.

Furthermore, an air injection nozzle that is not shown can be arranged on the inlet 12, preferably in the vicinity of a port surface 8 of the inlet 12 to the cavity 7. The air injection nozzle ensures that the granulate that has not completely trickled into the feed section 11 is either blown into the feed section 11 or blown out of the port surface 8 up the funnel 12 by air blown in under pressure, so that the piston 31 can easily close the port surface 8.

The solid phase 21 of the feedstock 20 is heated in the plasticizing section 14 by means of the heater 15 and thereby converted into the liquid phase 22, which is able to emerge from the outlet port 16 when pressure is applied.

The temperature T along the axis 19b of the housing 19 is sketched on the right in FIG. 1.

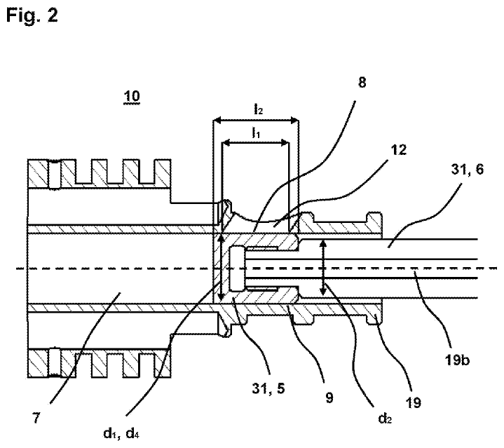

FIG. 2 shows the printhead 10 according to the invention in a sectional view of a vertical section through the printhead 10. Piston 31 has a first piston section 5 facing the plasticizing section 14, with a guide surface 9 through which piston 31 is guided in a cavity 7 of the printhead 10 or of the housing 19.

The axial extension l₂ of the guide surface 9 is longer than the maximum axial extension l₁ of a port surface 8 of the inlet 12 to the cavity 7. The port surface 8 of the inlet 12 to the cavity 7 is designed in such a way that the supplied granulate 21 can be optimally fed into the cavity or into the feed section 11.

The axial extension l₂ of the guide surface 9 of the piston 31 is preferably between 1.5 and 1.7 times, in particular 1.6 times, the maximum axial extension l₁ of the port surface 8.

Furthermore, the first piston section 5 has a distance d₁, d₄.

The piston 31 shown with the correspondingly dimensioned guide surface 9 prevents the piston 31 from jamming in the cavity 7 and reduces the penetration of the deformed granulate into the gap between the guide surface 9 and the cavity 7.

The piston 31 also has the second piston section 6, whose piston diameter d₂ is smaller than a horizontal distance d₁ of the first piston section 5, where this can be a horizontal distance d₁, a horizontal diagonal d₄ or a horizontal diameter di of the first piston section 5.

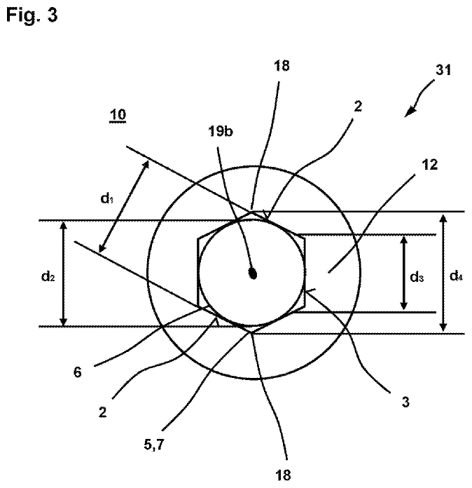

FIG. 3 shows a sectional view of a horizontal section of the piston 31 of a first exemplary embodiment, wherein the piston 31 is prevented from radial twisting within the cavity 7 of the printhead 10. Piston 31 is prevented from radial twisting by a form-fitting connection between the first piston section 5 and the cavity 7 of the printhead 10.

In this embodiment, the first piston section 5 and the cavity 7 of the printhead 10 have a polygonal, in particular hexagonal, cross-sectional surface.

The first piston section 5 forms a flat surface 3 on its side facing the port surface 8, and a maximum horizontal diameter d₃ of the port surface 8 is smaller here than a horizontal distance d₄ of the first piston section 5. The horizontal distance d₄ is the distance of a diagonal of two opposite edges 18 of the polygonal base surface of the first piston section 5.

Furthermore, the second piston section 6 is shown, the piston diameter d₂ of which is smaller than a horizontal distance d₁ of the first piston section 5, where the horizontal distance di of the first piston section 5 is the distance between the parallel opposing surfaces 2 of the first piston section 5.

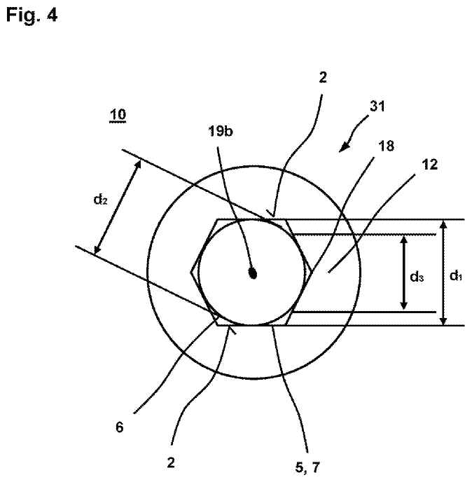

FIG. 4 shows a sectional view of a horizontal section of the piston 31 of a second exemplary embodiment, wherein the piston 31 is prevented from the cavity 7 of the printhead 10 against radial twisting. Piston 31 is prevented from radial twisting by a form-fitting connection between the first piston section 5 and the cavity 7 of the printhead 10.

In this embodiment, the first piston section 5 and the cavity 7 of the printhead 10 have a polygonal, in particular hexagonal, cross-sectional surface.

The first piston section 5 has two parallel flat surfaces. Furthermore, one edge 18 of the piston section 5 is aligned centrally with the port surface 8 and the maximum horizontal diameter ds of the port surface 8 is smaller than the horizontal distance d₁ of the parallel flat surfaces 2 of the first piston section 5.

In a third exemplary embodiment, not shown, the first piston section 5 and the cavity 7 of the printhead 10 have a part-circular, in particular semi-circular cross-sectional surface.

In a fourth exemplary embodiment, not shown, the first piston section 5 and the cavity 7 of the printhead 10 have a cross-sectional surface in the shape of a segment of a circle.

A segment of a circle describes a partial surface of a circular surface that is bounded by an arc and a chord.

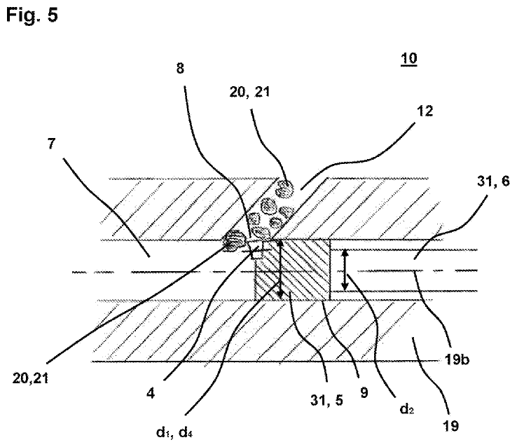

FIG. 5 shows a further exemplary embodiment of the printhead 10 in a sectional view of a vertical section through the printhead 10, wherein the first piston section 5 has a cutting edge 4 for shearing the feedstock 21 in granular form at the port surface 8 of the inlet 12. The cutting edge 4 is formed from a hardened material and, in the form shown here, has a separate cutting tool, in particular a turning plate.

The piston 31 also has the first piston section 5 facing the plasticizing section 14, with the guide surface 9, through which the piston 31 is guided in the cavity 7 of the printhead 10 or the housing 19.

The port surface 8 of the inlet 12 to the cavity 7 is designed in such a way that the supplied granulate 21 can be optimally fed into the cavity or into the feed section 11.

Furthermore, the first piston section 5 has the distance d₁, d₄.

The piston 31 shown with the correspondingly dimensioned guide surface 9 prevents the piston 31 from jamming in the cavity 7 and reduces the penetration of the deformed granulate into the gap between the guide surface 9 and the cavity 7.

The piston 31 also has the second piston section 6, whose piston diameter d₂ is smaller than the distance d₁, d₄ of the first piston portion 5.

The printhead 10 can be integrated into any 3D printer.

1. A printhead (10) for a 3D printer (1), the printhead comprising: a feed section (11) with an inlet (12) for feedstock (21) having a variable viscosity, a plasticizing section (14) with a heater (15) and an outlet port (16) for a liquid phase (22) of the feedstock (21), and a delivery device (30) for delivering the feedstock (21) from the feed section (11) to the plasticizing section (14), wherein the delivery device (30) comprises a piston (31) that can be introduced into the feed section (11), and the piston (31) has a first piston section (5) facing the plasticizing section (14) and includes a guide surface (9), by which the piston (31) is guided in a cavity (7) in the printhead (10),
wherein
the piston (31) is prevented from radial twisting within the cavity (7) in the printhead (10).

2. The printhead (10) according to claim 1,
wherein
the piston (31) is prevented from radial twisting by a form-fitting connection of the first piston section (5) with the cavity (7) of the printhead (10).

3. The printhead (10) according to claim 1,
wherein
the first piston section (5) and the cavity (7) of the printhead (10) have a polygonal, in cross-sectional surface.

4. The printhead (10) according to claim 1,
wherein
the first piston section (5) and the cavity (7) of the printhead (10) have a part-circular cross-sectional surface.

5. The printhead (10) according to claim 1,
wherein
the first piston section (5) and the cavity (7) of the printhead (10) have a cross-sectional surface in a shape of a segment of a circle.

6. The printhead (10) according to claim 1,
wherein
an axial extension (l₂) of the guide surface (9) of the piston (31) is between 1.5 and 1.7 times a maximum axial extension (l₁) of a port surface (8) of the inlet (12) to the cavity (7).

7. The printhead (10) according to claim 1,
wherein
the first piston section (5) has a cutting edge (4) for shearing the feedstock (21) at a port surface (8) of the inlet (12).

8. The printhead (10) according to claim 3, wherein the first piston section (5) and the cavity (7) of the printhead (10) have a hexagonal cross-sectional surface.

9. The printhead (10) according to claim 1, wherein the first piston section (5) and the cavity (7) of the printhead (10) have a semicircular cross-sectional surface.
